(19) United States
(12) Patent Application Publication
(10) Pub. No.: US 2025/0334092 A1
(43) Pub. Date: Oct. 30, 2025

(54) FUEL INJECTOR HAVING NOZZLE CHECK WITH TRANSFER HOLES ORIENTED FOR REDUCED MIXING OF TWO FUELS

(71) Applicant: Caterpillar Inc., Peoria, IL (US)

(72) Inventor: Eric L. Schroeder, Germantown Hills, IL (US)

(73) Assignee: Caterpillar Inc., Peoria, IL (US)

(21) Appl. No.: 18/650,561

(22) Filed: Apr. 30, 2024

(51) Int. Cl. F02M 43/04; F02M 67/12

(52) U.S. Cl. CPC F02M 43/04; F02M 67/12; F02M 2200/44

(57) ABSTRACT

A fuel injector includes a nozzle having a combined-fuel outlet passage fluidly connected to a first fuel passage and a second fuel passage and extending to a plurality of nozzle outlets. A nozzle check movable in the nozzle includes a plurality of transfer holes fluidly connecting the first fuel passage through the nozzle check to the combined-fuel outlet passage. The plurality of transfer holes are orientated to limit mixing between two liquid fuels in a combined fuel charge in the combined-fuel outlet passage. The combined fuel charge may be formed of a leading compression-ignition liquid fuel such as diesel and a trailing liquid fuel such as methanol. Related apparatus and methodology is also disclosed.

### TECHNICAL FIELD

The present disclosure relates generally to a fuel injector configured for injecting a combined fuel charge of two liquid fuels, and more particularly to transfer hole orientations for limiting mixing of two fuels in a combined fuel charge in a fuel injector.

### BACKGROUND

Dual fuel engine systems have been known for decades. While traditional engine systems typically utilize a single fuel type such as diesel, gasoline, or natural gas, in a dual fuel engine system two different fuels each having different desirable properties are typically combusted together in an engine cylinder.

In one known strategy, a relatively small pilot charge of a compression-ignition fuel such as diesel is used to ignite a relatively larger main charge of a gaseous fuel such as natural gas. The diesel fuel is relatively easily ignited by way of an increased temperature and pressure in a cylinder, with the ignition of the diesel fuel triggering ignition of the gaseous fuel.

More recently, engineers have proposed dual liquid fuel strategies employing a leading fuel and a trailing fuel, both in a liquid form and injected as a single fuel charge. U.S. Pat. No. 11,384,721 B1 proposes a strategy that may operate by injecting a leading diesel fuel followed by a trailing alcohol fuel from the same passage into an engine cylinder for combustion. While the '721 patent undoubtedly has practical applications, there is always room for improvement and development of alternative strategies.

### SUMMARY

In one aspect, a fuel injector includes a nozzle defining a longitudinal axis and having formed therein a plurality of nozzle outlets, a first fuel passage, a second fuel passage, and a combined-fuel outlet passage fluidly connected to the first fuel passage and to the second fuel passage and extending to the plurality of nozzle outlets. The fuel injector further includes a nozzle check movable in the nozzle between a closed position blocking the plurality of nozzle outlets, and an open position. The first fuel passage extends through the nozzle check to a plurality of transfer holes formed in the nozzle check and fluidly connected to the combined-fuel outlet passage. The plurality of transfer holes have orientations including at least one of a tangential component or an axially advancing component, relative to the longitudinal axis.

In another aspect, a fuel system includes a first fuel supply of a first fuel, and a second fuel supply of a second fuel. The fuel system also includes a fuel injector defining a longitudinal axis, and having formed therein a first fuel inlet fluidly connecting a first fuel supply to a first fuel passage, a second fuel inlet fluidly connecting the second fuel supply to a second fuel passage, and a combined-fuel outlet passage extending to a plurality of nozzle outlets. The fuel injector further includes a nozzle check movable between a closed position blocking the plurality of nozzle outlets, and an open position. The nozzle check includes a plurality of transfer holes formed therein fluidly connecting the first fuel passage to the combined-fuel outlet passage, and having orientations including at least one of a tangential component or an axially advancing component, relative to the longitudinal axis.

In still another aspect, a method of operating a fuel system includes feeding a first fuel to a fuel injector, and displacing some of a second fuel from a combined-fuel outlet passage in the fuel injector with the first fuel so as to form a combined fuel charge in the combined-fuel outlet passage. The method further includes admitting the first fuel to the combined-fuel outlet passage via transfer holes extending at orientations having at least one of a tangential component or an axially advancing component relative to a longitudinal axis of the fuel injector. The method still further includes injecting the combined fuel charge into a cylinder in an engine for combustion.

### BRIEF DESCRIPTION OF DRAWINGS

FIG. 1 is a diagrammatic view of an internal combustion engine system, according to one embodiment;

FIG. 2 is a sectioned side diagrammatic view of a fuel injector, according to one embodiment;

FIG. 3 is a sectioned view of a portion of a fuel injector, according to one embodiment;

FIG. 4 is a sectioned view of a fuel injector nozzle, according to one embodiment;

FIG. 5 is a sectioned view of a fuel injector nozzle check, according to one embodiment;

FIG. 6 is another sectioned view of a nozzle check, according to one embodiment;

FIG. 7 is a diagrammatic view graphically illustrating constituents and state of a dual fuel charge, according to one embodiment;

FIG. 8 is a graph illustrating substitution ratios for a fuel injector according to the present disclosure in comparison to a known design; and

FIG. 9 is a view, in two section planes, of a fuel injector nozzle check according to one embodiment.

### DETAILED DESCRIPTION

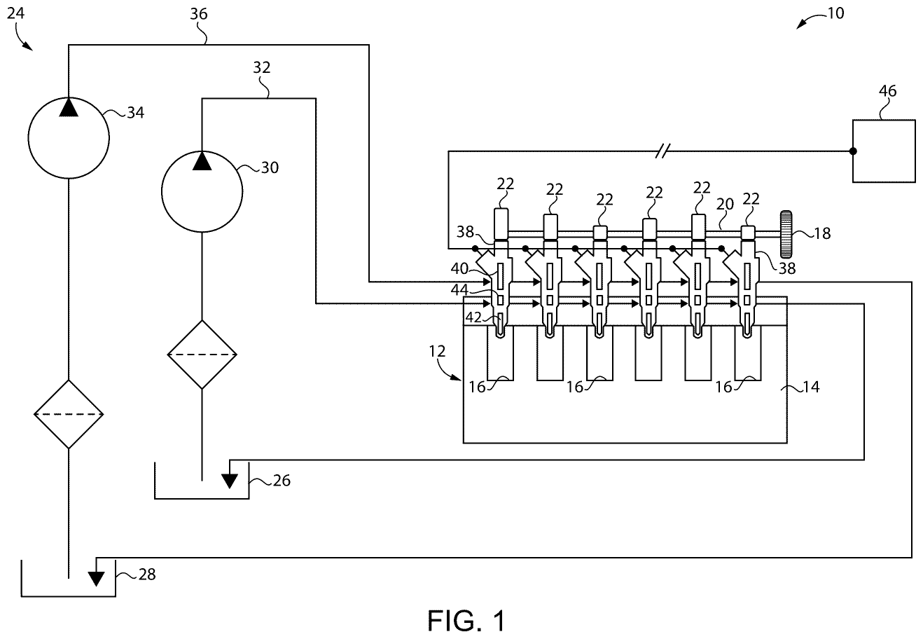

Referring to FIG. 1, there is shown an internal combustion engine system 10 according to one embodiment. Engine system 10 includes an engine 12 having an engine housing 14 with a plurality of cylinders 16 formed therein. Cylinders 16 can include any number of cylinders in any suitable arrangement such as an in-line pattern, a V-pattern or still another. A cam gear 18 in an engine geartrain is supported on engine housing 14 and rotates in a generally conventional manner to rotate a camshaft 20 having a plurality of cam lobes 22. Engine system 10 can be applied for any known purpose including operating an electrical generator, a pump, a compressor, or a driveline in a land vehicle or a marine vessel to name a few examples.

Engine system 10 also includes a fuel system 24 having a first fuel supply 26 of a first fuel, and a second fuel supply 28 of a second fuel. The first fuel may include a suitable compression-ignition liquid fuel such as a diesel distillate fuel or a higher octane fuel with a cetane enhancer. The second fuel can include a higher octane fuel including an alcohol fuel such as methanol. It should be appreciated the present disclosure is not limited to any particular fuel type or difference in cetane number or octane number between the two fuels, and various fuels and fuel blends are within the scope of the present disclosure.

Fuel system 24 also includes a first fuel pump 30 structured to feed the first fuel as a liquid via a first fuel supply conduit 32 to engine 12. Fuel system 24 also includes a second pump 34 structured to feed the second fuel as a liquid via a second fuel supply conduit 36 to engine 12. More than one fuel pump for each fuel, and any fuel pump type, may be used within the present context. The first fuel and the second fuel are fed to a plurality of fuel injectors 38 of fuel system 24 and each positioned to extend into a respective one of cylinders 16. Fuel injectors 38 may thus include direct fuel injectors structured to directly inject a fuel charge of the first fuel, the second fuel, or a combined fuel charge of the first fuel and the second fuel, into the corresponding one of cylinders 16.

Cylinders 16 are conventionally equipped with pistons operable to reciprocate in response to combustion of the injected fuel charge and air therein to rotate a crankshaft operating a load in a generally conventional manner. In one practical application, a combined fuel charge consisting of the first fuel leading and the second fuel trailing may be injected in each engine cycle. A combined fuel charge as such may include a relatively smaller quantity of the compression-ignition first fuel, such as diesel, leading, and a relatively larger quantity of the second fuel, such as methanol, trailing. It has been discovered that a segmented fuel charge of this general type can provide various advantages respecting reduction of certain emissions. The compression-ignition first fuel auto-ignites in the cylinder to trigger ignition of the relatively larger amount of the second fuel.

Each fuel injector 38, hereinafter referred to, at times, in the singular, includes a fuel pressurization plunger 40 actuated by a respective one of cam lobes 22 to pressurize a combined-fuel charge to an injection pressure for injection, a nozzle check 42, and a valve assembly 44. While in the illustrated embodiment plunger 40 is cam-actuated, in other embodiments fuel pressurization could be achieved by way of a hydraulically actuated plunger, or by another fuel pressurization strategy altogether. Engine system 10 also includes a control system 46 including a suitable computerized electronic control unit, computer readable memory, and other known elements to electronically control fuel injectors 38 such as by way of electrical control currents, and potentially other components of engine system 10.

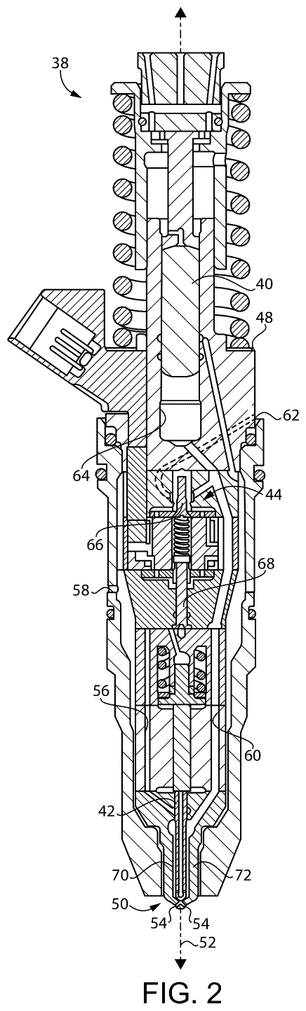

Referring also now to FIG. 2, fuel injector 38 includes an injector housing 48 having a nozzle 50 defining a longitudinal axis 52. Nozzle 50 has formed therein a plurality of nozzle outlets 54. Injector housing 48 and nozzle 50 also have formed therein a first fuel passage 56 and a first fuel inlet 58 extending to first fuel passage 56 to fluidly connect to first fuel supply 26, a second fuel passage 60 and a second fuel inlet 62 extending to second fuel passage 60. Injector housing 48 also has formed therein a plunger cavity 48. Plunger 40 is movable in plunger cavity 48 to pressurize a combined fuel charge of the first fuel admitted via first fuel inlet 58 and the second fuel admitted via second fuel inlet 62.

As noted above, fuel injector 38 also includes a valve assembly 44. Valve assembly 44 may include a spill valve 66 movable between an open position fluidly connecting plunger cavity 64 to second fuel inlet 62, and a closed position. Valve assembly 44 may also include an injection control valve 68. Injection control valve 68 is movable to control a closing hydraulic pressure acting upon nozzle check 42 to control a timing and potentially a manner of fuel injection according to well-known techniques. Nozzle check 42 is movable in nozzle 50 between a closed position blocking nozzle outlets 54, and an open position. Valve assembly 44 may be electrically actuated, such as solenoid actuated, and made from known parts operated according to generally known techniques.

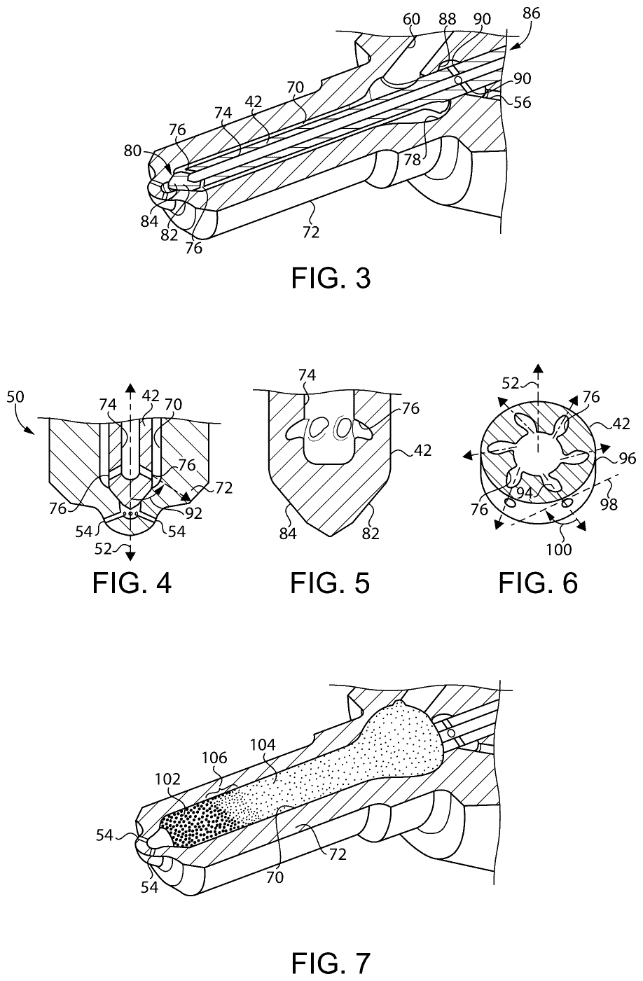

Nozzle 50 also has formed therein a combined-fuel outlet passage 70 fluidly connected to first fuel passage 56 and to second fuel passage 60. Combined-fuel outlet passage 70 extends to nozzle outlets 54. As noted above, nozzle check 42 is movable in nozzle 50 to open and close nozzle outlets 54. First fuel passage 56 extends through nozzle check 42 and includes an outgoing passage segment 74 within nozzle check 42. Referring also now to FIG. 3, there are shown features of nozzle check 42 in further detail. First fuel passage 56 and outgoing passage segment 74 extend through nozzle check 42 to a plurality of transfer holes 76 formed in nozzle check 42. Transfer holes 76 are fluidly connected to combined-fuel outlet passage 70. Transfer holes 76 may have orientations including a radial component and at least one of a tangential component and an axially advancing component relative to longitudinal axis 52. A “radial component” means along a radius of a circle centered on longitudinal axis 52. A “tangential component” means in a direction of a line tangent to a circle centered on longitudinal axis 52. An “axially advancing component” means in a direction that advances along or parallel to longitudinal axis 52 away from a geometric center point of fuel injector 38. As shown in the attached Figures, embodiments may include transfer holes having orientations with a radial component, a tangential component, and an axially advancing component. Orientations of transfer holes 76 assist in limiting mixing between the first fuel and the second fuel when forming a combined fuel charge in combined-fuel outlet passage 70, as further discussed herein.

With continued focus on FIG. 3, a fuel cavity 78 extends circumferentially around nozzle check 42 and fluidly connects second fuel passage 60 to combined-fuel outlet passage 70. Transfer holes 76 open to combined-fuel outlet passage 70 at an axial location that is fluidly between fuel cavity 78 and nozzle outlets 54. As can also be seen from FIG. 3 nozzle check 42 includes a distal end 80 having a tip 82 with a conical seating surface 84 thereon, and a proximal end 86. In the illustrated embodiment, nozzle check 42 seats against a tip piece 72 having nozzle outlets 54 formed therein. A sac volume (not numbered) may extend axially between tip 82 and tip piece 72. An annulus 88 is also formed in nozzle 50 and in tip piece 72 and extends circumferentially around nozzle check 42 to fluidly connect outgoing passage segment 74 to an upstream portion of first fuel passage 56 by way of a plurality of fuel feed openings 90. Fuel feed openings 90 may be arranged circumferentially around nozzle check 42 and extend radially inward to outgoing passage segment 74.

Referring also now to FIGS. 4, 5, and 6, transfer holes 76 may be compound angularly oriented relative to longitudinal axis 52 and each defines an included angle 92 with longitudinal axis 52, and a swirl angle 101 between fuel paths 94 defined as center axes of transfer holes 76. Included angle 92 may include an acute angle, and opening in an axially downward direction, such that transfer holes 76 are axially advancing and angled downwardly in FIG. 4. An obtuse angle 100 is also understood to be defined between an example one of fuel paths 94 and a line 98 tangent to an outer surface of nozzle check 42.

As noted above, transfer holes 76 may have orientations including a tangential component relative to a circle centered on longitudinal axis 52. In FIG. 6 reference numeral 96 identifies an outer surface of nozzle check 42 defining said circle. As can be seen from FIG. 6, fuel paths 94 do not intersect longitudinal axis 52 in the illustrated embodiment. Thus, the first fuel advancing through transfer holes 76 moves generally downward from outgoing passage segment 74, but also tangentially. The orientations of transfer holes 76 enable a swirl effect of the first fuel upon admission into a relatively quiescent resident volume of the second fuel as further discussed herein that limits mixing between the two fuels. In a practical implementation, a number of the plurality of transfer holes 76 is typically from 3-7, in a refinement greater than 4, and in a further refinement a total number of the plurality of transfer holes 76 is 6. Included angle 92 may be between about 45° and about 75° in some embodiments. As used herein the term “about” is to be understood to mean generally or approximately as would be understood by a person of ordinal skill in the fuel systems art, including within measurement error or conventional rounding as would be routinely applied.

Referring now also to FIG. 7, there is shown a diagrammatic illustration of tip piece 72 with a combined fuel charge therein within combined-fuel passage 70. Numeral 102 shows the first fuel as a leading fuel and numeral 104 shows the second fuel as a trailing fuel. It will be understood that reciprocation of plunger 40 increases pressures within fuel injector 38 to pressurize the combined fuel charge to an injection pressure. Admitting of the first fuel 102 to combined-fuel outlet passage 70 displaces some of the second fuel 104. Admitting of the first fuel can occur during an off-cycle of fuel injector 38, for example when the corresponding cam lobe 22 is rotating on its base circle and plunger 40 is not advancing or retracting. It has been observed that in certain instances two fuels combined in this way can mix undesirable at an interface 106 therebetween. The phenomenon is believed to be due at least in part to jets of the first fuel forming within the relatively quiescent second fuel and ultimately traveling somewhat upstream away from nozzle outlets 54. Mixing between the two fuels tends to reduce segmentation of the combined fuel charge, and can ultimately limit substitution ratios achievable, reduce ignitability of the combined fuel charge, or cause other problems. According to the present disclosure, relatively little mixing is expected to occur due at least in part to the axial advancement and/or the swirl of the first fuel relative to longitudinal axis 52 based upon the orientations of transfer holes 106.

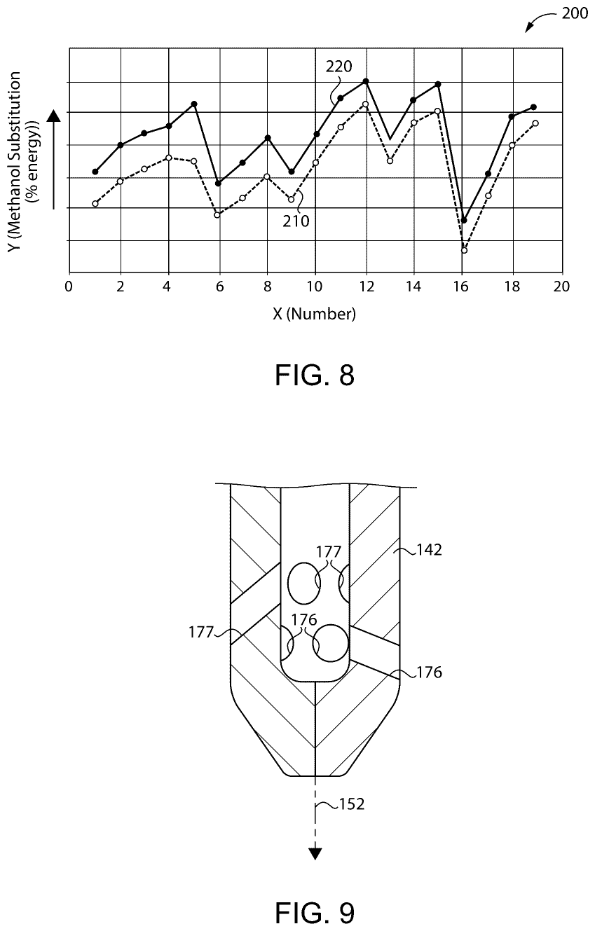

FIG. 8 illustrates a graph 200 showing actual test data illustrating methanol substitution in a dual fuel system according to a known design at 210 in comparison to the present disclosure at 220 for a plurality of test points. The known design 210 used four radial holes oriented with no axially advancing or tangential component. The design of the present disclosure at 220 used holes oriented at a swirl angle. It can be seen that numeral 220 shows relatively higher methanol to diesel substitution at a plurality of measurement points believed to be due to the reduced mixing between the two liquid fuels.

Referring to FIG. 9, there is shown a fuel injector nozzle check 142 according to another embodiment. Nozzle check 142 includes two rows of transfer holes, including a first or lower row 176 and a second or upper row 177. In the illustrated embodiment, nozzle check 142 includes four lower transfer holes 176 and four upper transfer holes 177 for a total of eight transfer holes, although other hole numbers including a total number of holes ranging from three to seven or potentially more might be used. Embodiments are also contemplated having unequal numbers of transfer holes between the upper row and the lower row in any combination. Transfer holes 176 and transfer holes 177 may have orientations each including at least one of an axially advancing component or a tangential component consistent with other embodiments discussed herein. Also consistent with other embodiments discussed herein, transfer holes 176 and 177 may define included angles with a longitudinal axis 152 from approximately 45° to approximately 75°. In some embodiments, the orientations of transfer holes 176 and transfer holes 177 may be different, defining different included angles in the lower row versus the upper row, or even varying within the respective rows. In some instances, the use of two rows or sets of transfer holes may provide for a reduced pressure drop over single-row designs and/or increased structural integrity of nozzle check 142 as a spacing among transfer holes opening to the inside of nozzle check 142 may be relatively larger.

### INDUSTRIAL APPLICABILITY

Referring to the drawings generally, operating fuel system 24 in engine system 10 can include feeding the first fuel to each of the plurality of fuel injectors 38. Within each fuel injector 38, at appropriate engine crank angle timings, the first fuel can be admitted to the respective combined-fuel outlet passage 70 via transfer holes 76 to displace some of the second fuel from combined-fuel outlet passage 70. Supplying pressure and flow of the first fuel to displace the second fuel could be by way of opening a valve, turning on or increasing output of a pump, or by a combination of these or other strategies. Admitting of the first fuel forms a combined fuel charge in the combined-fuel outlet passage 70. Meanwhile, plunger 50 is reciprocating to exchange the second fuel between plunger cavity 64 and first fuel inlet 62 so long as spill valve 66 is open.

When spill valve 66 is actuated closed, movement of plunger 40 in response to cam rotation increases the pressure in plunger cavity 64 and in second fuel passage 60, communicating the same increase in pressure to combined-fuel outlet passage 70. As will be apparent to those skilled in the art, injection control valve 68 can be energized to momentarily relieve a closing hydraulic pressure on nozzle check 42 to enable pressure in combined-fuel outlet passage 70 to lift nozzle check 42 and inject the combined fuel charge into a cylinder for combustion. Upon injection the leading first fuel will compression-ignite to trigger ignition of a relatively larger charge of the second fuel.

The present description is for illustrative purposes only, and should not be construed to narrow the breadth of the present disclosure in any way. Thus, those skilled in the art will appreciate that various modifications might be made to the presently disclosed embodiments without departing from the full and fair scope and spirit of the present disclosure. Other aspects, features and advantages will be apparent upon an examination of the attached drawings and appended claims. As used herein, the articles “a” and “an” are intended to include one or more items, and may be used interchangeably with “one or more.” Where only one item is intended, the term “one” or similar language is used. Also, as used herein, the terms “has,” “have,” “having,” or the like are intended to be open-ended terms. Further, the phrase “based on” is intended to mean “based, at least in part, on” unless explicitly stated otherwise.

What is claimed is:

1. A fuel injector comprising:
a nozzle defining a longitudinal axis and having formed therein a plurality of nozzle outlets, a first fuel passage, a second fuel passage, and a combined-fuel outlet passage fluidly connected to the first fuel passage and to the second fuel passage and extending to the plurality of nozzle outlets;
a nozzle check movable in the nozzle between a closed position blocking the plurality of nozzle outlets, and an open position; and
the first fuel passage extending through the nozzle check to a plurality of transfer holes formed in the nozzle check and fluidly connected to the combined-fuel outlet passage, and the plurality of transfer holes having orientations including at least one of a tangential component or an axially advancing component, relative to the longitudinal axis.

2. The fuel injector of claim 1 wherein the plurality of transfer holes are compound angularly oriented and each defines an included angle with the longitudinal axis, and is oriented at a swirl angle relative to a line tangent to a circle centered on the longitudinal axis.

3. The fuel injector of claim 2 wherein the included angle opens in an axially outward direction.

4. The fuel injector of claim 2 wherein the included angle is from about 45°to about 75°.

5. The fuel injector of claim 4 wherein a number of the plurality of transfer holes is from 3 to 7.

6. The fuel injector of claim 1 wherein the plurality of transfer holes are arranged in a lower row and an upper row.

7. The fuel injector of claim 1 wherein the nozzle check includes a distal end having a tip with a conical seating surface thereon, and a proximal end.

8. The fuel injector of claim 7 wherein the proximal end has formed therein a plurality of fuel feed openings, and the first fuel passage includes an outgoing passage segment extending through the nozzle check from the plurality of fuel feed openings to the plurality of transfer holes.

9. The fuel injector of claim 8 further comprising:
an injector housing forming a first fuel inlet extending to the first fuel passage, a second fuel inlet, and a plunger cavity;
a plunger movable in the plunger cavity to pressurize a combined fuel charge of a first fuel admitted via the first fuel inlet and a second fuel admitted via the second fuel inlet; and
a spill valve movable between an open position fluidly connecting the plunger cavity to the second fuel inlet, and a closed position.

10. The fuel injector of claim 8 wherein:
a fuel cavity extends circumferentially around the nozzle check and fluidly connects the second fuel passage to the combined-fuel outlet passage; and
the plurality of transfer holes open to the combined-fuel outlet passage at a location that is fluidly between the fuel cavity and the plurality of nozzle outlets.

11. A dual fuel system comprising:
a first fuel supply of a first fuel;
a second fuel supply of a second fuel;
a fuel injector defining a longitudinal axis, and having formed therein a first fuel inlet fluidly connecting the first fuel supply to a first fuel passage, a second fuel inlet fluidly connecting the second fuel supply to a second fuel passage, and a combined-fuel outlet passage extending to a plurality of nozzle outlets;
a nozzle check movable in the injector housing between a closed position blocking the plurality of nozzle outlets, and an open position; and
the nozzle check having a plurality of transfer holes formed therein fluidly connecting the first fuel passage to the combined-fuel outlet passage, and having orientations including at least one of a tangential component or an axially advancing component relative to the longitudinal axis.

12. The fuel system of claim 11 wherein the fuel injector defines a longitudinal axis, and each of the plurality of transfer holes defines an included angle with the longitudinal axis opening in an axially outward direction.

13. The fuel system of claim 11 wherein each of the plurality of transfer holes defines a swirl angle relative to a line tangent to a circle center on the longitudinal axis.

14. The fuel system of claim 13 wherein and a total number of the plurality of transfer holes is greater than 4.

15. The fuel system of claim 11 wherein the fuel injector further includes a cam-actuated plunger movable in a plunger cavity to pressurize a combined fuel charge of the first fuel and the second fuel, and a spill valve movable between an open position fluidly connecting the plunger cavity to the second fuel inlet, and a closed position.

16. The fuel system of claim 11 wherein the nozzle check includes a distal end having a tip with a conical seating surface thereon, and a proximal end having formed therein a plurality of fuel feed openings, and the first fuel passage includes an outgoing passage segment extending through the nozzle check from the plurality of fuel feed openings to the plurality of transfer holes.

17. A method of operating a fuel system comprising:
feeding a first fuel to a fuel injector;
displacing some of a second fuel from a combined-fuel outlet passage in the fuel injector with the first fuel so as to form a combined fuel charge in the combined-fuel outlet passage;
admitting the first fuel to the combined-fuel outlet passage via transfer holes extending at orientations having a radial component and at least one of a tangential component or an axially advancing component relative to a longitudinal axis of the fuel injector; and
injecting the combined-fuel charge into a cylinder in an engine for combustion.

18. The method of claim 17 further comprising limiting mixing of the first fuel and the second fuel via swirling flow of the first fuel in the combined-fuel outlet passage.

19. The method of claim 18 wherein the transfer holes are formed in a nozzle check of the fuel injector and fluidly connect a fuel passage extending through the nozzle check to the combined-fuel outlet passage.

20. The method of claim 17 wherein the first fuel includes a compression-ignition fuel, and the combined fuel charge includes the first fuel as a leading fuel and the second fuel as a trailing fuel.
